(19) United States
(12) Patent Application Publication
(10) Pub. No.: US 2015/0360537 A1
(43) Pub. Date: Dec. 17, 2015

(54) APPARATUS OF HVAC SYSTEM FOR VEHICLE

(71) Applicants: Hyundai Motor Company, Seoul (KR); Kia Motors Corp., Seoul (KR)

(72) Inventors: June Kyu PARK, Hwaseong-si (KR); Yong Chul KIM, Hwaseong-si (KR)

(73) Assignees: Hyundai Motor Company, Seoul (KR); Kia Motors Corp., Seoul (KR)

(21) Appl. No.: 14/555,228

(22) Filed: Nov. 26, 2014

(30) Foreign Application Priority Data
Jun. 17, 2014 (KR) 10-2014-0073239

(51) Int. Cl. B60H 1/00

(52) U.S. Cl. CPC B60H 1/00742; B60H 1/00028; B60H 1/00064; B60H 1/00207; B60H 1/00285; B60H 1/00671; B60H 2001/00185

(57) ABSTRACT

An apparatus of a heating, ventilating, and air conditioning (HVAC) system for a vehicle may include a controlling unit determining whether or not a passenger may be present, a plurality of branched channels to which a fluid introduced from an air blower passes through an evaporator and may be then introduced, heaters respectively formed to correspond to the channels, and mode doors formed to allow the channels to be opened and closed between the branched channels.

### CROSS REFERENCE TO RELATED APPLICATION

The present application claims priority to Korean Patent Application No. 10-2014-0073239, filed Jun. 17, 2014, the entire contents of which is incorporated herein for all purposes by this reference.

### BACKGROUND OF THE INVENTION

1. Field of the Invention

The present invention relates to an apparatus of a heating, ventilating, and air conditioning (HVAC) system for a vehicle which performs an air-conditioning control of a driver seat, a passenger seat, and a back seat in the HVAC system of the vehicle by separating the driver seat, the passenger seat, and the back seat from one another.

2. Description of Related Art

In an air-conditioning apparatus for a vehicle, which is an apparatus for heating and cooling, or ventilating an indoor of the vehicle, so called left and right independent type air-conditioning apparatus allowing fluids having different temperature to be supplied to a driver seat and a passenger seat in the indoor of the vehicle according to a necessary of a passenger to thereby perform separate heating and cooling has recently been used.

In addition, according to the related art, the driver seat-centered heating and cooling has been conducted such that a structure activating a high voltage positive temperature coefficient (PTC) to distinguish a fluid in an outlet into the driver seat and the passenger seat is configured in the HVAC to adjust a direction of a door in the case in which the passenger is not present in the passenger seat.

Particularly, since the cooling and heating itself may serve as a load during the driving due to the recent introduction of an eco-friendly car, an apparatus capable of obtaining a maximum cooling and heating effect using minimum power has been developed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus of a HVAC system for a vehicle capable of adjusting a direction and an amount of cooling and heating depending on a position of a passenger by sensing the position of the passenger.

In an aspect of the present invention, an apparatus of a heating, ventilating, and air conditioning (HVAC) system for a vehicle may include a controlling unit determining whether or not a passenger is present, a plurality of branched channels to which a fluid introduced from an air blower passes through an evaporator and is then introduced, heaters respectively formed to correspond to the channels, and mode doors formed to allow the channels to be opened and closed between the branched channels.

The plurality of channels may include a driver seat channel having a first heater formed therein, a passenger seat channel having a second heater formed therein, and

a back seat channel, wherein the passenger seat channel is provided with the back seat channel branched from the passenger seat channel and may have a third heater formed therein.

The back seat channel is positioned at an upper side of the passenger seat channel.

The mode doors may include a first mode door and the driver seat channel and the passenger seat channel may have the first mode door formed to be openable and closeable therebetween, the first mode door being formed to block or guide a fluid moved to a passenger seat channel side.

The mode doors may include a second mode door and the passenger seat channel and the back seat channel may have the second mode door formed to be openable and closeable therebetween, the second mode door being formed to block or guide a fluid moved to a back seat channel side.

The plurality of channels may include a driver seat channel branched into a driver seat side and having a first heater formed therein, a passenger seat channel branched into a passenger seat side and having a second heater formed therein, and a back seat channel extended from the evaporator to a rear side of the vehicle in a length direction and having a third heater formed therein.

The back seat channel is branched into a left part and a right part at a rear side of the third heater.

The back seat channel is provided with a partition extended from the evaporator and formed to separate the first heater and the second heater.

The mode doors may include a third mode door and the driver seat channel and the back seat channel may have the third mode door formed to be openable and closeable therebetween, the third mode door being formed to block or guide a fluid moved to a back seat channel side.

The mode doors may include a fourth mode door and the passenger seat channel and the back seat channel may have the fourth mode door formed to be openable and closeable therebetween, the fourth mode door being formed to block or guide a fluid moved to a back seat channel side.

The mode doors may include a fifth mode door and the passenger seat channel and the back seat channel may have the fifth mode door formed to be openable and closeable therebetween, the fifth mode door being formed to block or guide a fluid moved to a passenger seat channel side.

The apparatus may further include a temperature door formed between the evaporator and the heaters.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1, FIG. 2, FIG. 3, FIG. 4, FIG. 5, FIG. 6 and FIG. 7 are views illustrating an apparatus of a HVAC system for a vehicle according to an exemplary embodiment of the present invention.

FIG. 8, FIG. 9, FIG. 10 and FIG. 11 are views illustrating an apparatus of a HVAC system for a vehicle according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an apparatus of a HVAC system for a vehicle according to exemplary embodiments of the present invention will be described with reference to the accompanying drawings.

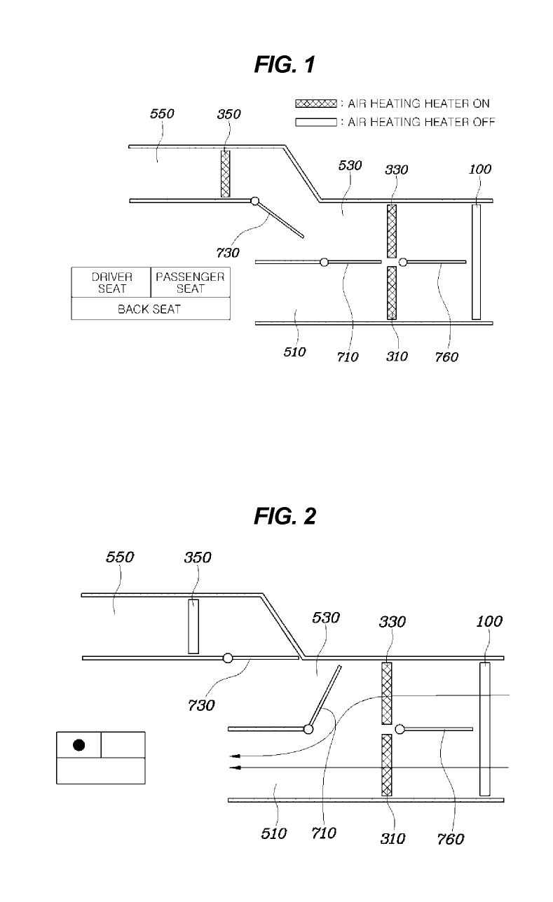

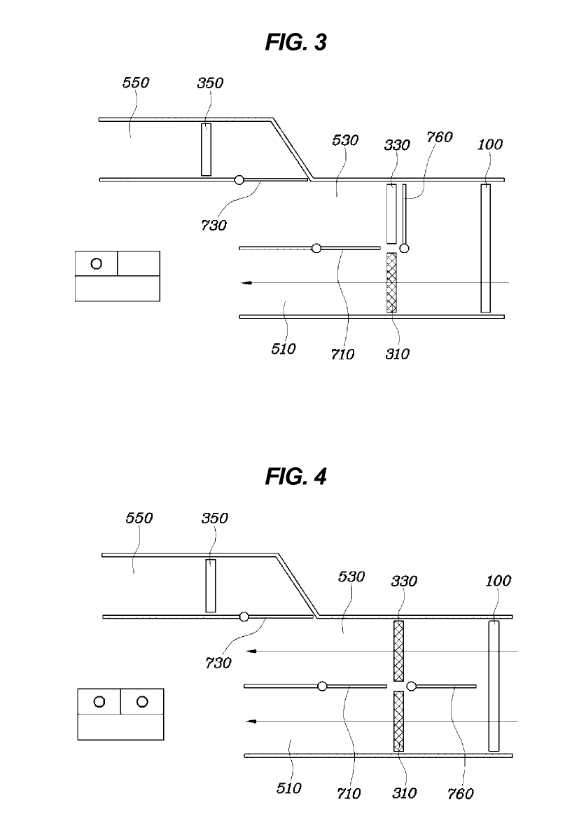

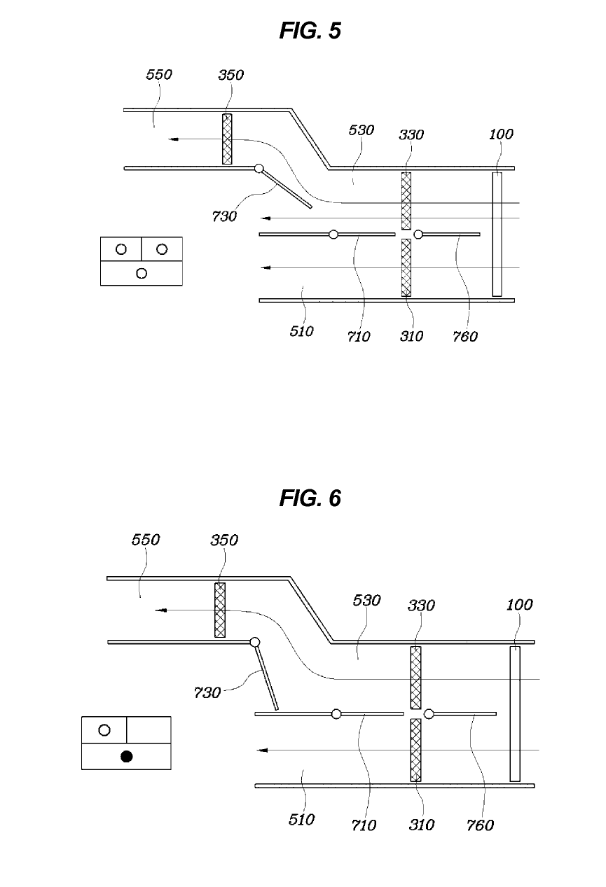

FIGS. 1 to 7 are views illustrating an apparatus of a HVAC system for a vehicle according to an exemplary embodiment of the present invention. The apparatus of the HVAC system for the vehicle according to the exemplary embodiment of the present invention includes: a controlling unit 10 determining whether or not a passenger is present, a plurality of branched channels 510, 530, and 550 to which a fluid introduced from an air blower passes through an evaporator 100 and is then introduced, heaters 310, 330, and 350 respectively formed to correspond to the channels 510, 530, and 550, and mode doors 710 and 730 formed to allow the channels to be opened and closed between the branched channels 510, 530, and 550 and the channels 510, 530, and 550.

The present invention is to determine whether or not a passenger is present by the controlling unit 10 to thereby intensively heat a seat side on which the passenger is positioned. Since a technology recognizing the passenger by the controlling unit 10 is a known technology, a detailed description thereof will be omitted in the present specification. In addition, the present invention may also be applied to the cooling by driving the evaporator 100, or the like in the HVAC system.

FIG. 1 is a view illustrating a structure of the apparatus of the HVAC system for the vehicle according to the exemplary embodiment of the present invention, where the fluid introduced through the air blower and evaporator 100 is introduced through the plurality of branched channels 510, 530, and 550. The channels 510, 530, and 550 are provided with the heaters 310, 330, and 350 formed to correspond to the respective channels 510, 530, and 550. The heaters 310, 330, and 350 may be positive temperature coefficient (PTC) heaters. In addition, the mode doors 710 and 730 formed to be openable and closeable may be formed between the channels 510, 530, and 550 and the channels 510, 530, and 550 to block or guide the introduced fluid and a temperature door 760 may be formed between the evaporator 100 and the heaters 310 and 330.

More specifically, the plurality of channels 510, 530, and 550 are branched into a driver seat channel 510, a passenger seat channel 530, and a back seat channel 550. The back seat channel 550 may be positioned at an upper side of the passenger seat channel 530. In addition, the driver seat channel 510 is provided with a first heater 310, the passenger seat channel 530 is provided with a second heater 330, and the back seat channel 550 is provided with a third heater 350, which is a structure different from a structure according to the related art in which one heater is used for the driver seat channel and the passenger seat channel.

In addition, a first mode door 710 may be formed to be openable and closeable between the driver seat channel 510 and the passenger seat channel 530 and may be opened so that a fluid moving toward the passenger seat channel 530 side may be blocked or the fluid may be moved to the passenger seat channel 530 side to thereby guide the fluid. A second mode door 730 may be formed between the passenger seat channel 530 and the back seat channel 550 and may be opened so that a fluid moving toward the back seat channel 550 side may be blocked or the fluid may be moved to the back seat channel 550 side to thereby guide the fluid.

According to the respective cases, forms that the heaters 310, 330, and 350, the mode doors 710 and 730, and the temperature door 760 are operated will be illustrated by FIGS. 2 to 7.

First, FIGS. 2 and 3 illustrate cases in which only the passenger seated on the driver seat is confirmed. FIG. 2 illustrates an operation form of a case in which a rapid heating toward the driver seat is required while confirming that the passenger is seated on only the driver seat. In a state in which the controlling unit recognizes that the passenger is present on only the driver seat, when the passenger wants the rapid heating by manipulating a switch, or the like in the indoor, the first heater 310 in the driver seat channel 510 and the second heater 330 in the passenger seat channel 530 are simultaneously driven. In addition, the controlling unit controls the first mode door 710 so that the first mode door 710 blocks the passenger seat channel 530. Accordingly, the first mode door 710 guides the fluid so that all of the fluids passing through the first heater 310 and the second heater 330 may be delivered to the driver seat side. In this case, the temperature door 760 is in an opened state so that both the first heater 310 and the second heater 330 may be used. In addition, the third heater 350 in the back seat channel 550 side is not driven and the second mode door 730 is maintained in a closed state.

Similarly, FIG. 3 illustrates an operation form of a case in which a typical heating is required in a state in which the controlling unit recognizes that the passenger is seated on only the driver seat. Unlike the case of FIG. 2, the temperature door 760 closes the second heater 330 in the passenger seat channel 530 to thereby adjust an air volume so that the fluid passing through the first heater 310 may be delivered to the driver seat side by driving only the first heater 310 of the driver seat channel 510. In this case, the third heater 350 in the back seat channel 550 is not driven and the first mode door 710 and the second mode door 730 guide all of the fluids in the closed state so that all of the fluids may pass through only the driver seat channel 510.

FIG. 4 illustrates an operation form upon performing the heating in a state in which the controlling unit recognizes that passengers are seated on the driver seat and the passenger seat. The first heater 310 in the driver seat channel 510 and the second heater 330 in the passenger seat channel 530 are driven and the temperature door 760 and the first mode door 710 are opened to allow the fluid to be moved to the respective channels, such that the same heating performance may be secured in the driver seat and the passenger seat. In this case, the third heater 350 in the back seat channel 550 is not driven and the second mode door 730 is maintained in a closed state.

FIG. 5 illustrates an operation form upon performing the heating in a state in which the controlling unit recognizes that passengers are seated on the driver seat, the passenger seat, and the back seat. All of the first heater 310 in the driver seat channel 510, the second heater 330 in the passenger seat channel 530, and the third heater 350 in the back seat channel 550 are driven and all of the temperature door 760, the first mode door 710, and the second mode door 730 are opened to allow the fluid to be moved to the respective channels, such that the same heating performance may be secured in all of the seats.

FIG. 6 is a view illustrating an operation form in the case in which the passenger manipulates the switch, or the like in the indoor to perform the rapid heating of the back seat in a state in which the controlling unit recognizes that the passengers are seated on the driver seat and the back seat. All of the first heater 310 in the driver seat channel 510, the second heater 330 in the passenger seat channel 530, and the third heater 350 in the back seat channel 550 are driven and the temperature door 760 and the first mode door 710 are opened. However, the second mode door 730 is opened in the back seat channel 550, but blocks the passenger seat channel 530 to thereby allow the fluid heated by the second heater 330 to be again heated by the third heater 350 while being introduced into the back seat channel 550, thereby securing rapid heating performance of the back seat. In this case, the passenger seat channel 530 is closed by the second mode door 730, such that the fluid is not moved to the passenger seat channel 530.

FIG. 7 is a view illustrating an operation form of a case in which the controlling unit recognizes that the passengers are seated on the driver seat and the back seat, as a general mode of FIG. 6. FIG. 7 has the same configuration as that of FIG. 6, but has only a difference that the second heater 330 in the passenger seat channel 530 is not driven. Therefore, the same heating performance of the driver seat and the back seat may be secured.

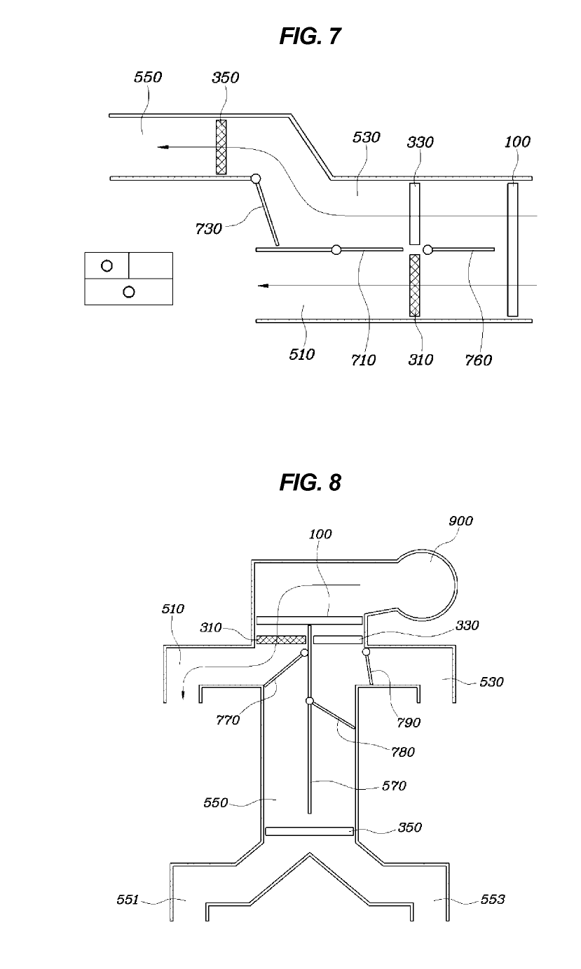

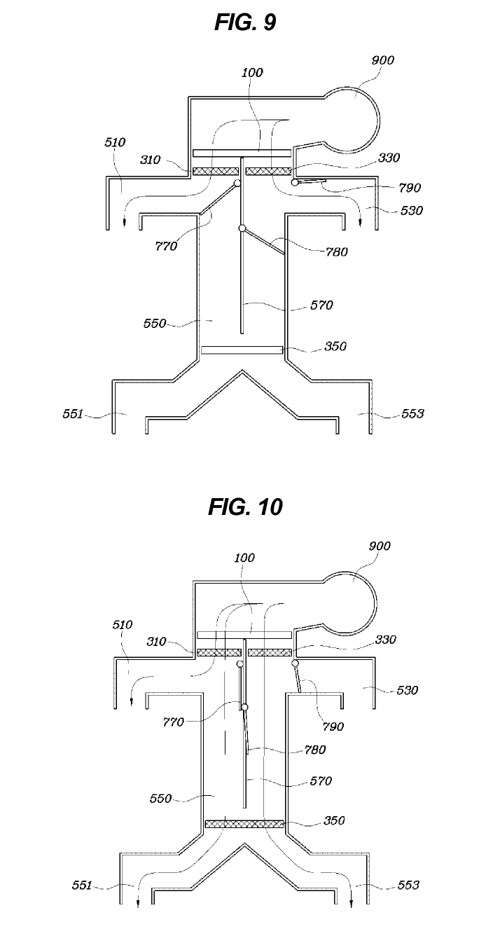

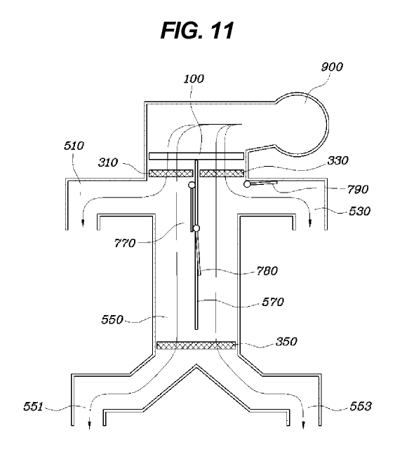

FIGS. 8 to 11 are views illustrating an apparatus of a HVAC system for a vehicle according to another exemplary embodiment of the present invention. The apparatus of the HVAC system for the vehicle according to another exemplary embodiment of the present invention includes: a controlling unit determining whether or not a passenger is present, a plurality of branched channels 510, 530, and 550 to which a fluid introduced from an air blower 900 passes through an evaporator 100 and is then introduced, heaters 310, 330, and 350 respectively formed to correspond to the channels 510, 530, and 550, and mode doors 770, 780, and 790 formed to allow the channels 510, 530, and 550 to be opened and closed between the branched channels 510, 530, and 550 and the channels 510, 530, and 550.

More specifically, the plurality of channels are provided with a back seat channel 550 penetrating through the evaporator 100 and then lengthily extended to the back seat side along a length direction of the vehicle and a partition 570 formed to be extended from the evaporator 100 by a predetermined distance. The partition 570 is not formed to be extended up to the third heater 350 formed in the back seat channel 550. The left (driver seat side) and the right (passenger seat side) of the partition 570 are provided with the driver seat channel 510 and the passenger seat channel 530, respectively, the driver seat channel 510 is provided with the first heater 310, and the passenger seat channel 530 is provided with the second heater 330. The back seat channel 550 may be branched into a left part 551 and a right part 553 at a rear side of the third heater 330.

In addition, a third mode door 770 may be formed to be openable and closeable between the driver seat channel 510 and the back seat channel 550 to block or guide the fluid moved to the back seat channel 550 side. Similarly, a fourth mode door 780 may be formed to be openable and closeable between the passenger seat channel 530 and the back seat channel 550 to block or guide the fluid moved to the back seat channel 550 side. Additionally, a fifth mode door 790 may be formed to be openable and closeable between the passenger seat channel 530 and the back seat channel 550 to block or guide the fluid moved to the passenger seat channel 530 side.

FIG. 8 is a view illustrating an operation of a case in which the controlling unit recognizes that the passenger is seated on only the driver seat, where the fluid passing through the evaporator 100 passes through the first heater 310 and is guided by the third mode door 770, thereby being delivered to the driver seat channel 510. In this case, all of the second heater 330 in the passenger seat channel 530 and the third heater 330 in the back seat channel 550 are not driven and the third mode door 770, the fourth mode door 780, and the fifth mode door 790 are maintained in a closed state.

FIG. 9 is a view illustrating an operation of a case in which the controlling unit recognizes that the passengers are seated on the driver seat and the passenger seat, where the first heater 310 in the driver seat channel 510 and the second heater 330 in the passenger seat channel 530 are driven, such that the fluid passing through the evaporator 100 passes through the first heater 310 and the second heater 330 and is delivered to the driver seat channel 510 and the passenger seat channel 530, respectively. The fifth mode door 790 allowing the passenger seat channel 530 to be opened and closed is in an opened state, and the third mode door 770 and the fourth mode door 780 are in a closed state. In this case, the third heater 350 is not driven.

FIG. 10 is a view illustrating an operation of a case in which the controlling unit recognizes that the passengers are seated on the driver seat and the back seat, where all of the first heater 310 in the driver seat channel 510, the second heater 330 in the passenger seat channel 530, and the third heater 350 in the back seat channel 550 are driven. However, the third mode door 770 and the fourth mode door 780 are opened, but the fifth mode door 790 in the passenger seat channel 530 is closed, such that the fluid is guided so as not be moved to the passenger seat channel 530. In addition, since the fluid moved to the back seat channel 550 is heated two times in the present exemplary embodiment, higher heating efficiency may be obtained.

FIG. 11 is a view illustrating an operation of a case in which the controlling unit recognizes that the passengers are seated on the driver seat, the passenger seat, and the back seat, where all of the first heater 310 in the driver seat channel 510, the second heater 330 in the passenger seat channel 530, and the third heater 350 in the back seat channel 550 are driven similar to FIG. 10. In addition, all of the third mode door 770, the fourth mode door 780, and the fifth mode door 790 are opened to allow the fluid to be delivered to all of the driver seat channel 510, the passenger seat channel 530, and the back seat channel 550.

In case of an electric car, a low voltage PTC may be used. In addition, as illustrated in FIGS. 10 and 11, since the fluid moved to the back seat channel 550 is already heated by the first heater 310 and the second heater 330 before passing through the third heater 350, the third heater 350 in the back seat channel 550 may not be driven in the case in which heating load is decreased during the driving.

According to the apparatus of the HVAC system for the vehicle having the structure as described above, the heated fluid passing through the evaporator and the heater is not forcedly blocked and is guided by the mode door, such that the noise due to the flow resistance of the fluid may be removed and the heat exchange may be advantageously performed because the hot fluid does not stagnate. Therefore, only the back seat channel may be separately controlled so that the heated fluid is not separately discharged to the seat in which the passenger is not present by recognizing the position of the passenger by the controlling unit.

In addition, since two or more heaters may be simultaneously used, it is possible to rapidly perform the heating according to the need of the user and to heat the back seat even in the case in which the third heater formed in the back seat channel to reduce the load during the driving is not driven and only the first heater and the second heater are driven.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus of a heating, ventilating, and air conditioning (HVAC) system for a vehicle, the apparatus comprising:
a controlling unit determining whether or not a passenger is present;
a plurality of branched channels to which a fluid introduced from an air blower passes through an evaporator and is then introduced;
heaters respectively formed to correspond to the channels; and
mode doors formed to allow the channels to be opened and closed between the branched channels.

2. The apparatus of claim 1, wherein the plurality of channels includes:
a driver seat channel having a first heater formed therein;
a passenger seat channel having a second heater formed therein; and
a back seat channel,
wherein the passenger seat channel is provided with the back seat channel branched from the passenger seat channel and has a third heater formed therein.

3. The apparatus of claim 2, wherein the back seat channel is positioned at an upper side of the passenger seat channel.

4. The apparatus of claim 2, wherein the mode doors include a first mode door and the driver seat channel and the passenger seat channel have the first mode door formed to be openable and closeable therebetween, the first mode door being formed to block or guide a fluid moved to a passenger seat channel side.

5. The apparatus of claim 2, wherein the mode doors include a second mode door and the passenger seat channel and the back seat channel have the second mode door formed to be openable and closeable therebetween, the second mode door being formed to block or guide a fluid moved to a back seat channel side.

6. The apparatus of claim 1, wherein the plurality of channels includes:
a driver seat channel branched into a driver seat side and having a first heater formed therein;
a passenger seat channel branched into a passenger seat side and having a second heater formed therein; and
a back seat channel extended from the evaporator to a rear side of the vehicle in a length direction and having a third heater formed therein.

7. The apparatus of claim 6, wherein the back seat channel is branched into a left part and a right part at a rear side of the third heater.

8. The apparatus of claim 6, wherein the back seat channel is provided with a partition extended from the evaporator and formed to separate the first heater and the second heater.

9. The apparatus of claim 6, wherein the mode doors include a third mode door and the driver seat channel and the back seat channel have the third mode door formed to be openable and closeable therebetween, the third mode door being formed to block or guide a fluid moved to a back seat channel side.

10. The apparatus of claim 6, wherein the mode doors include a fourth mode door and the passenger seat channel and the back seat channel have the fourth mode door formed to be openable and closeable therebetween, the fourth mode door being formed to block or guide a fluid moved to a back seat channel side.

11. The apparatus of claim 6, wherein the mode doors include a fifth mode door and the passenger seat channel and the back seat channel have the fifth mode door formed to be openable and closeable therebetween, the fifth mode door being formed to block or guide a fluid moved to a passenger seat channel side.

12. The apparatus of claim 1, further comprising a temperature door formed between the evaporator and the heaters.
